(19) United States
(12) Patent Application Publication
(10) Pub. No.: US 2004/0234187 A1
(43) Pub. Date: Nov. 25, 2004

(54) Method of and apparatus for measuring nonstationary oscillatory motion

(76) Inventors: Lid B. Wong, Elmhurst, IL (US); Hua Mao, San Diego, CA (US); Tarun Chandra, Gurnee, IL (US); Donovan B. Yeates, Chicago, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/824,742

(22) Filed: Apr. 15, 2004

Related U.S. Application Data
(63) Continuation-in-part of application No. 10/184,393, filed on Jun. 27, 2002, now abandoned.

(51) Int. Cl. G02B 6/00

(52) U.S. Cl. 385/13

(57) ABSTRACT

A method of measuring nonstationary oscillatory motion of a sample is disclosed. The method comprisesing the steps of illuminating a sample with an illuminating optical fiber; detecting reflectedbackscattered light from the sample with a plurality of detecting optical fibers; coupling each optical fiber of the plurality of detecting optical fibers with a modulating optical fiber; and generating measurements of the nonstationary oscillatory motion of the sample. An apparatus for measuring nonstationary oscillatory motion of a sample is also disclosed. The apparatus comprises a light source; an illuminating optical fiber coupled to the light source; and a plurality of optical fibers positioned around the illuminating optical fiber and coupled to receive reflectedbackscattered light from the sample.

### CROSS REFERENCE TO RELATED APPLICATION

This Application is a continuation-in-part of application Ser. No. 10/184,393, filed Jun. 27, 2002.

### GOVERNMENT SUPPORT

The present invention was made with U.S. Government support from the National Institutes of Health, National Heart, Lung and Blood, Institute, under grant No. HL 59816. The U.S. government has certain rights in this invention.

### FIELD OF THE INVENTION

This invention relates generally to diagnostic systems, and in particular, to a method of and apparatus for measuring oscillatory motion.

### BACKGROUND OF THE INVENTION

A number of techniques have been described for characterizing ciliary oscillatory motion. However, such prior art techniques have significant limitations which make them unacceptable for use in diagnostic instruments. That is, the physical requirements of a device used in a technique may prevent its use in an intact human or animal. Similarly, some prior art devices are not sensitive enough to be used for dynamic analysis. For example, one particular problem with many prior art devices is that only a single fiber and detector areis used. One prior art device utilized a single illuminating and a single detecting fiber fixed at a particular converging angle to maximize signal to noise ratio and, as a result, could not be used for measurement in an intact animal or human.

Prior art systems have measured small oscillatory motions of an irregular surface using coherent light of sufficient divergence so that there are reflections both from the vibrating surface and from adjacent stationary surfaces. The backscattered light was analyzed using techniques of speckle interferometry to produce measurements of vibration frequency (assuming the adjacent surface is indeed stationary). This system, which was designed for use in acoustics, utilized a single source of divergent illumination, making it impossible to identify the sources of the backscattered light. Such a system is too insensitive to be used for dynamic analysis.

Several other prior art methods use speckle interferometry to study objects or surfaces, both statically and dynamically. Such methods split a laser beam into reference and object beams, illuminate the study object with the object beam, and then combine the light backscattered from the object with the reference beam to develop information about the object. Examples include defect detection, vibration mapping of an oscillating object, transient motion from a scattering surface, speed measurement, displacement measurement, or optical coherence tomography. These methods utilize a single object beam and a single reference beam, and/or rigid optics, making them unsuitable for measurement of ciliary activity and its meta-characteristics in an intact human or animal.

Similarly, a vibrometer was developed for measuring the displacement or velocity of the bones of the middle ear. The device utilized diffuse reflectance from the textural surface of laser light delivered and collected via optical fibers and analyzed via speckle interferometry. The device used a single laser source beam and a single detector and, as a result, could not be used for dynamic analysis of ciliary activity and its meta-characteristics. In one embodiment, a three dimensional vibrometer was described that used three laser beams which were arranged in mutual orthogonal directions, making it impracticable to measure ciliary oscillatory motion as described in the system of the present invention.

Several prior art devices relate to the use of single beams of laser light directed to a surface and the detection of backscattered light using either homodyne or heterodyne methods to determine such variables as surface velocity and displacement, ultrasonic surface displacement, particle size distribution in an oscillating flow field, microorganism velocity, or vibration of an object. Because they generally use only a single beam and detector, they cannot develop information about spatial distribution of ciliary activity. Many also utilize rigid optics and are unsuitable for measurement of ciliary activity and its meta-characteristics in an intact human or animal.

Similarly, many of the techniques or devices could only be used with excised tissue or cell culture because the device for measuring ciliary activity must be positioned at a specific, predetermined angle. For example, a prior art fiber-optic instrument for measuring ciliary activity of oviducts in vitro utilizeding a single illuminating fiber and a single detecting fiber which converged at an angle of 22.5° and, in order to produce a signal with acceptable signal to noise ratio, had to be positioned at exactly 45° to the tissue surface. As a result, it could not be used for measurement in an intact animal or human. Similarly, a system for in vivo measurement of ciliary activity in the human nose used variation in the intensity of light reflectedbackscattered from the ciliated surface. The measurements were limited to an angle of 40° between the incident and reflectedbackscattered light beams and were subject to a great deal of noise and motion artifacts, making its ability to be used as a diagnostic instrument problematic. Finally, another prior art device forms an image of a cilium in situ, using illumination from a direction inclined 45 degrees or more to an optical axis and generating and detecting Fresnel reflectedbackscattered light. Such a method may be useful in imaging the cilia, but not for analysis of ciliary motion.

Another problem with prior art devices is that they often employed rigid tubes, making them unsuitable for use in an intact animal or human. Ciliary beat frequency has been measured in an intact animal using a heterodyne mode correlation analysis of laser light photons backscattered from the ciliated surface. However, the system utilized a rigid tube that could only detect photons backscattered at a particular angle. While the system was able to determine the ciliary beat frequency in vivo in an intact animal, it could not measure all available signals from the ciliated surface and therefore could not provide such information as the spatial distribution of the ciliary beat phases or meta-phenomena, as is possible with the present invention.

Further, some fiber optic measuring devices do not allow measurement of ciliary beat frequency and its spatial distribution in an intact animal. A rigid tube system has been used to measure the metachronal wave period of excised tracheal tissues. However, limitations in the design and the complexity and sensitivity of this system did not allow it to be used for measurement of ciliary beat frequency and its spatial distribution in an intact animal. Further, other prior art systems detected surface structures using several laser beam sources of differing wavelengths, each of which was split into a reference beam and a measuring beam, and utilized the methods of speckle interferometry to detect the surface structures from the phase differences in laser speckle pairs. The laser beams operated sequentially or simultaneously, but were not fixed in a particular geometric orientation relative to each other. Such a system cannot be used for dynamic analysis of such an oscillatory system as represented by ciliary activity. Finally, an endoscope device for detecting cilia motion using a single illuminating fiber and two detecting fibers pickeds up backscattered laser light from slightly different points on the epithelium. The differences between the signals from the two detecting fibers were used to cancel motion artifacts and increase the signal to noise ratio. However, this system does not use heterodyne mode correlation analysis nor does it develop information about any of the meta-phenomena that occur at the ciliated surface, such as the metachronal wave.

In addition, all of the prior art have the limitation that they can only analyze oscillatory signals that are stationary in nature, i.e., those that contain no stochastic elements and which do not vary during the time period of measurement. For such stationary signals, the classical techniques embodied in the prior art, including measurements at one or two points and analysis using autocorrelation in the time domain or spectral density functions in the frequency domain, may be adequate. Such techniques are not adequate for such nonstationary oscillatory processes as ciliary beat.

Cilia oscillate vertically in a nonstationary manner, while a horizontal metachronal wave field is superimposed upon this vertical motion. The nonstationary metachronal wave fields, made up of patches typically less than 100 micrometers in length, contain a stochastic element which superimposes a degree of randomness on the amplitude and direction of the metachronal wave field.

Because of this nonstationary nature of ciliary motion, accurate analysis of ciliary beat frequency and metachronal wave frequency requires that ciliary motion be mapped by simultaneous measurements at many points, using a plurality of detectors, on a distance scale smaller than the metachronal wave patch. None of the prior art can meet this requirement.

Accordingly, there is a need for an improved method of and apparatus for measuring ciliary oscillatory motion.

### BRIEF DESCRIPTION OF THE DRAWINGS

The accompanying drawings, which are incorporated in and form a part of this specification, illustrate embodiments of the invention and, together with descriptions, serve to explain the principles of the invention. They are not intended to limit the scope of the invention to the embodiments described. It will be appreciated that various changes and modifications can be made without departing from the spirit and scope of the invention as defined in the appended claims.

FIG. 1 is a block diagram of a system for measuring ciliary oscillatory motion according to the present invention.

FIG. 2 is a more detailed block diagram of a system for measuring ciliary oscillatory motion according to the present invention.

FIG. 3 is a cross-section of an illuminating/detecting fiber optic bundle used in a system for measuring ciliary oscillatory motion according to one embodiment of the present invention.

FIG. 4 is a cross-section of a modulating fiber optic bundle used in a system for measuring ciliary oscillatory motion according to one embodiment of the present invention.

FIG. 5 is a flow chart for a method of measuring ciliary oscillatory motion according to the present invention.

FIG. 6 is a flow chart for a method of measuring ciliary oscillatory motion according to an alternate embodiment of the present invention.

FIG. 7 is a flow chart for a method of measuring ciliary oscillatory motion according to an alternate embodiment of the present invention.

FIG. 8 shows time-dependent photon counts measured in one example of the present invention.

FIG. 9 shows a time-dependent photon count measured in another example of the present invention.

FIG. 10 shows the ciliary beat frequency and the metachronal wave period calculated from the data in FIG. 9.

### SUMMARY OF THE INVENTION

The present invention relates to the measurement and analysis of ciliary nonstationary oscillatory motion. Oscillatory motion has several characteristics: a particular frequency, a particular amplitude, and any superimposed pattern of wave characteristics that may be present. The present invention utilizes dynamic elastic laser light scattering to develop signals characteristic of the oscillatory motion, and heterodyne modulation of photons illuminating the cilia for ciliary oscillatory motion with photons bypassing the oscillator to determine the characteristics of the oscillation.

An object of the present invention is to enable remote detection and analysis of ciliary oscillatory motion and its meta-characteristics. This is accomplished by designing an illuminating/detecting fiberoptic bundle and a modulating fiberoptic bundle that each comprise fibers that are equally spaced in a particular spatial configuration; by pairing each illuminating/detecting fiber with a specific modulating fiber; by utilizing individual photon detectors for each pair of fibers; and, finally, by analyzing the results from each pair of fibers from multiple scattering angles in real time with heterodyne-mode laser light scattering techniques.

The invention preferably has a detection system comprising a bundle of optical detection fibers surrounding an illuminating fiber, a bundle of optical modulating fibers, gradient index (GRIN) lenses at either end of the detecting bundle, a GRINgradient index (GRIN) lens at the end of the modulating bundle proximalcloser to the light source, a single-mode low-power visible laser light source, a beam splitter, individual photon detectors for each pair of detector/modulator fibers, and a computer control system with the appropriate software to analyze the photon detector outputs.

This approach is superior to the existing technology in a number of ways. The use of optical fibers is superior to rigid optical systems in wide use because fiberoptic systems allow measurements to be made in places that are not otherwise accessible, such as for clinical diagnosis. The use of single-mode optical fibers is superior to conventional multi-mode fibers, because background light contamination and spurious higher order modes are eliminated, thus preserving the polarization of the incident light. The use of a set of optical fibers in a specific geometric configuration in the illuminator/detector and modulator bundles enables different pairs of fibers to be used at different scattering angles, for different shapes and dimensions of the scattering volume. Unlike existing technologies, it is possible to generate a spatial map of ciliary activity. Multiple measurements by several pairs of fibers enable the spatial coordination of ciliary activity to be measured simultaneously with ciliary beat frequency, which is not possible with existing technologies. Unlike signals from most existing devices, the detected signals are free from motion artifacts. The system also has a wider dynamic range and many fewer frequency limitations than existing systems. The use of heterodyne laser light scattering analysis is superior to conventional light intensity detection because of a greatly improved signal to noise ratio. The system is suitable for use in a variety of applications, as for example in non-invasive pulmonary or gynecological examinations using an endoscope, in addition to use in-vitro coupled to a microscope.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. The invention is intended to cover alternatives, modifications and equivalents, which may be included within the invention as defined by the appended claims.

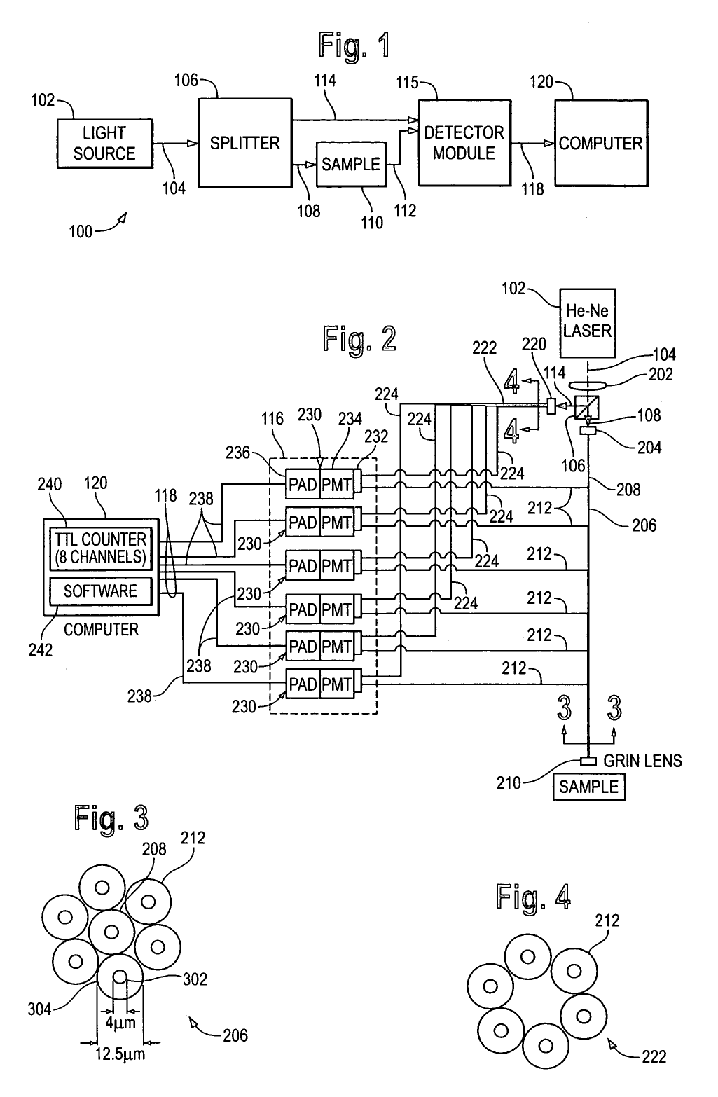

Turning now to FIG. 1, a measurement system 100 for measuring ciliary oscillatory motion of a sample is shown. In particular, a light source 102 generates a light beam 104. The light beam 104 is a coupled to an optical splitter 106. The optical splitter 106 generates a first light beam 108 which is preferably coupled to a sample 110, from which reflectedbackscattered light 112 can be detected by a detector module 116. A second light beam 114 from the splitter 106 is also coupled to thea detector module 116. The detector module 116 generates a detector output 118 which is coupled to a computer 120. As will be described in more detail in reference to the remaining Figures, the reflectedbackscattered light 112 and the second light beam 114 are analyzed to measure ciliary oscillatory motion. Turning now to FIG. 2, a more detailed block diagram shows a measuring system for measuring ciliary oscillatory motion of a sample according to the present invention. Generally, light from a helium-neon laser is focused on a 50/50 beam splitter. Half the light is focused by a GRIN lens on the illuminating fiber in the detector bundle, whence it is transmitted to the surface to be analyzed. The other half of the light from the beam splitter is focused by a GRIN lens on a bundle of modulator fibers, each of which is paired with a specific detector fiber. Light reflectedbackscattered back from the surface under observation is gathered by the detector fibers through a GRIN lens and transmitted to the detection system, where the light from each detector fiber is mixed with light from its paired modulator fiber and analyzed by a computer.

In particular, the light source 102, shown here as a He-Ne laser, couples the light beam 104 to an objective lens 202. The objective lens could be, for example, a 10× objective lens. The output of the objective lens is coupled to the splitter 106, which is shown here as a 50/50 beam splitter. The first light beam 108 is coupled to a GRIN lens 204. The GRIN lens 204 is coupled to a fiber optic bundle 206 by way of an illuminating fiber 208. An example of the fiber optic bundle 206 is shown in FIG. 3. The illuminating fiber 208 is coupled to a second GRIN lens 210. The fiber optic bundle 206 also includes a plurality of detecting fibers 212. The detecting fibers 212 are preferably single mode fibers to eliminate background noise and higher order modes. As will be described in more detail in reference to FIG. 3, the detecting fibers 212 detect light reflectedbackscattered from a sample 110 when the GRIN lens 210 is positioned near the sample.

The second light beam 114 is also coupled to a GRIN lens 220 which couples the second light beam to a second fiber optic bundle 222. An example of the second fiber optic bundle 222 is shown in FIG. 4. The fiber optic bundle 222 preferably comprises a plurality of modulator fibers 224. That is, each modulating fiber 224 of the fiber optic bundle 222 receives the modulating light from the light beam 114.

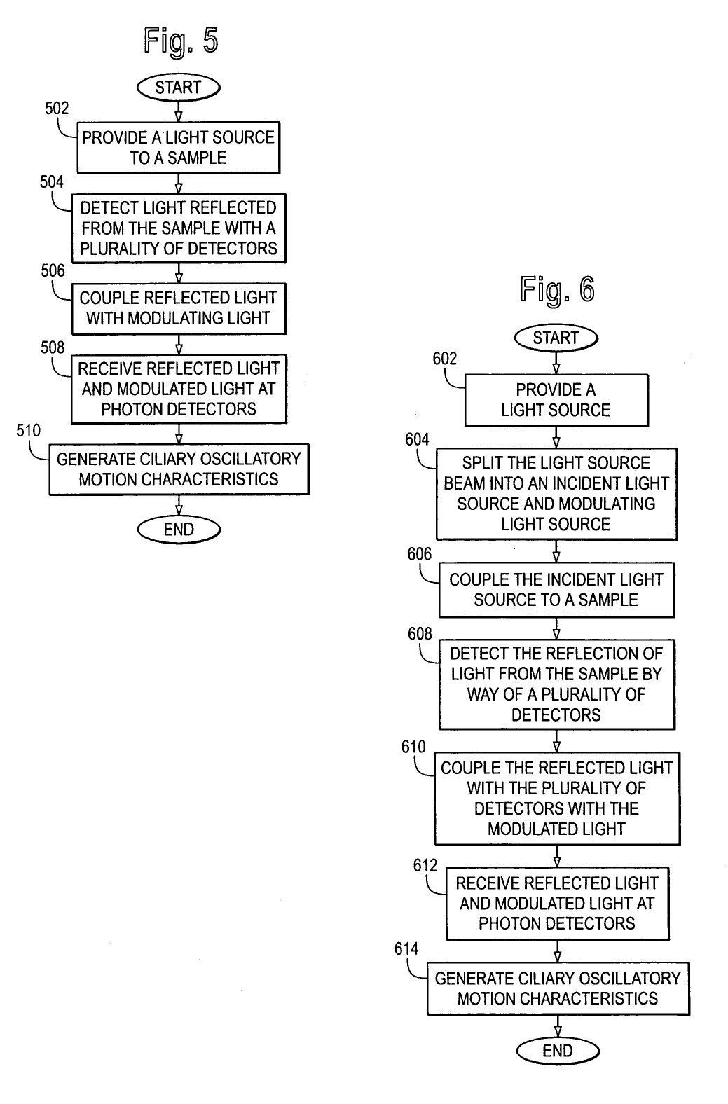

Each modulator fiber 2242 is also paired with a detecting fiber 212, and coupled to the detector module 116. In particular, each pair of detecting fibers 212 and modulating fibers 224 is coupled to a detector unit 230 comprising a GRIN lens 232, a photo multiplier tube (PMT) 234, and a pulse and amplifier discriminator (PAD) 236. Although a combination of a PMT and a PAD are shown, other detectors such as a charge coupled device or a photodiode which are well known in the art could be employed in the present invention. Each detector unit 230 receives signals from a pair of optical fibers, and generates an output 238 which is coupled to a TTL counter 240. TTL counter 240 is controlled by software 242 of the computer. As will be described in more detailed in reference to FIGS. 5 through 8, the TTL counters and software can enable the methods of measuring oscillatory motion of a sample according to the present invention.

Turning now to FIG. 3, a cross-sectional view of the illuminating/detecting fiber optic bundle 206 is shown. The illuminating fiber is preferably centered within the bundle of detector fibers that are symmetrically arranged around it. In particular, illuminating fiber 208 is surrounded by detecting fibers 212, which are preferably fixed, and are in a predetermined pattern with respect to the illuminating fiber to generate measurements related to the oscillatory motions of the sample. According to one embodiment of the invention, the optical fiber could be 4 micrometers, while the insulation could be 125 micrometers. Also shown in FIG. 4 is a cross-section of the second fiber optic bundle 222. The modulator bundle is similarly symmetrically arranged around an empty core, and could also include single mode fibers of the same dimension.

Turning now to FIG. 5, a flow chart shows a method of measuring oscillatory motion of a sample according to the present invention. In particular, a light source is provided to a sample at a step 502. Light reflectedbackscattered from the sample is detected with a plurality of detectors at a step 504. The backscatteredreflective light is then coupled with modulating light at a step 506. The reflectedbackscattered light and the modulated light are received at photon detectors at a step 508. Finally, ciliary oscillatory motion characteristics are generated at a step 510. The method of FIG. 5 could be performed using the device of FIGS. 1 and 2, or any other suitable device.

Turning now to FIG. 6, a flow chart shows a method of measuring oscillatory motion of a sample according to an alternate embodiment of the present invention. A light source is provided at a step 602. The light source beam is split into an incident light source beam and a modulating light source beam at a step 6042. The incident light source beam is coupled to a sample at a step 606. The reflectedbackscattered light from the sample is detected by way of a plurality of detectors at a step 608. The reflectedbackscattered light is then coupled with the modulated light at a step 610. The reflectedbackscattered light and the modulated light are then received at a photon detector at a step 612. The ciliary oscillatory motion characteristics are then generated at a step 614. The method of FIG. 6 could also be performed using the device of FIGS. 1 and 2, or any other suitable device.

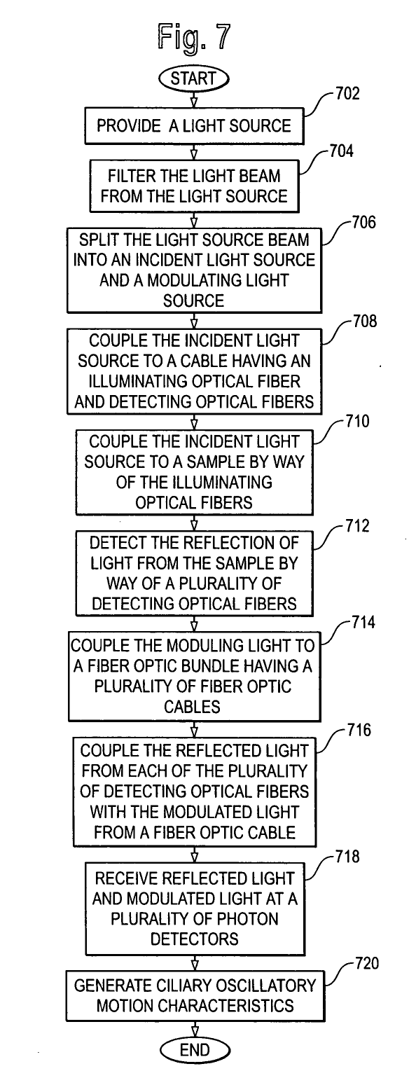

Turning now to FIG. 7, a method for measuring oscillatory motion according to an alternate embodiment of the present invention is shown. A light source is provided at a step 702. The light source could be, for example, a HeE-NeE laser as shown in FIG. 2. The light beam from the light source is then filtered at a step 704. The filter could be, for example, an objective lens, such as the 10× objective lens 202 shown in FIG. 2. The light beam is then split into an incident light source and a modulating light source at a step 706.

The light beam could be split, for example, by the 50/50 beam splitter 106 shown in FIG. 2 or some other suitable component. The incident light source is coupled to a cable having an illuminating optical fiber and detecting optical fibers at a step 708. The cable could be, for example, the fiber optic bundle 206 of FIG. 2. The incident light source is coupled to the sample by way of the illuminating optical fiber at a step 710. The reflectedbackscattered light from the sample is detected by way of a plurality of detecting optical fibers at a step 712. The detecting optical fibers could be, for example, the detecting optical fibers 212 of FIG. 2.

The modulating light source is also coupled to a fiber optic bundle having a plurality of optical fibers at a step 714. The fiber optic bundle could be, for example, the fiber optic bundle 222 of FIG. 2. The reflectedbackscattered light from each of the plurality of detecting optical fibers is then coupled with the modulated light at a step 716. Preferably, each detecting optical fiber is individually coupled to a separate modulating optical fiber. The reflectedbackscattered light and the modulated light are then received at a plurality of photon detectors at a step 718. Finally, the ciliary oscillatory motion characteristics are generated at a step 720. For example, power spectral densities (PSD) of the photon count sequences from the photon detector(s) are obtained using wavelet analysistransformation, periodogram convolution analysis, or cumulative autocorrelation analysis. Further, the ciliary beat frequencies and metachronal wave period of the cilia are simultaneously derived from the frequency spectrum obtained from the PSD.

The temporal variation in photon counts, detected by the photodetector, contains information pertinent to the intensity fluctuations of the backscattered light from the cilia. The ciliary beat frequency can be obtained from the dominant term in a frequency domain representation of the photon count sequences i.e. the power density spectrum. The area under the power density spectrum is proportional to the power of the backscattered light signal.

One method of estimating the power density spectrum involves the reduction of the high frequency noise component of the backscattered light signal prior to a Fourier transformation of the photon count sequence. This noise reduction is achieved by a multilevel decomposition of the original photon count signal using a technique called wavelet analysis. This technique involves a convolution of the original signal with a low pass and a complementary high pass filter to yield two sets of coefficients, namely, approximation coefficients containing the low frequency components and detail coefficients containing the high frequency components of the signal. The signal represented by the approximation coefficients alone is further decomposed into a second level of approximation and detail coefficients. This process is repeated at several levels. When a reconstruction is performed using only the approximation coefficients from the multi-level decompositions, a denoised representation of the original signal is obtained.

Another method of estimating the power density spectrum, namely the Periodogram, involves the Fourier transformation of the autocorrelation function of the photon count sequence. In order to reduce the error in this estimation, several independent estimates of the Periodogram can be averaged. This technique is called periodogram convolution analysis.

Finally, another method of estimating the power density spectrum involves the Fourier transformation of a denoised autocorrelation function obtained from the photon count sequence. In this technique, the autocorrelation function is estimated in a cumulative fashion by analyzing the photon count sequence over an extended period of time using a moving window which spans a shorter, fixed duration in time. This technique is called cumulative autocorrelation analysis.

The following are examples of particular applications of the present method and apparatus. A PCI bus-based, multi-channel counter timer computer board was configured for the system. Another multi-channel counter timer board was used to provide the gate signal for the buffered photon event counting operations. The two devices were connected using a real time system integration (RTSI) bus connector. An interval measurement technique was used to count photon events. The photon counting device simultaneously sampled 5V transistor-transistor logic (TTL) voltage signals from up to 8 photon detecting devices.

The 6 channel photon count data acquisition software program consists of the following functions. A Set_Gate_Device function programs the gating device to generate the gateing pulse over the RTSI bus. Its frequency value can be defined in a range above 0 and up to 5 KHz. A Set_The_Counters function programs up to 8 counters on the photon counting board for buffered period measurement. The above two functions complete the setup operations on the counters and are invoked first in the main control program. After setup is complete and event signals are connected to source pins of counters on the photon counting board, an Arm_Counters function can be called to start the gateing pulse and thus the counting. Whenever a reading of the counts is desired, the Counter function may be called to return back an 8 by 512 array of counts for the counters. 512 points are read from the counter buffer for each of a maximum of 8 counters from the current read mark. The last function, Disarm_Counters, stops the counting operations and resets both the gating and photon counting devices.

Source code written in C performs data acquisition by communicating with the photon counting counter/timer board. Matlab code interfaced with the C code is used for processing the data acquired through the circular buffer of the counter/timer board. The data processing, available on all 8 channels, performs the following operations. The raw photon count data in each counting cycle is reduced by the mean photon counts of its respective channel (clipping). A cumulative autocorrellation (cumulant analysis) is performed on each of the above channel mean-clipped photon count data. The resultant data from all 8 channels is concatenated to a single array and is based on a user selectable option, either its power spectrum density (PSD) is calculated or the fast Ffourier transforms (FFT) of the channels are individually calculated. After 60 Hz noise filtering and elimination of the DC leak component, the dominant frequency is calculated based on the highest spectral peak component and the resultant PSD/FFT is displayed. The dominant frequency, classified as ciliary beat frequency, is time-stamped and written to a file stored on the PC's hard drive.

### EXAMPLE 1

### Measurements of Ciliary Activity In Vivo in Dogs

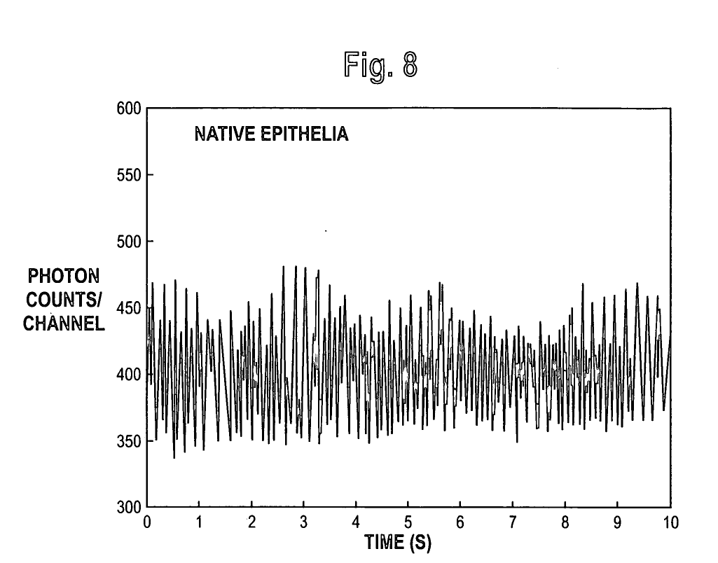

Adult beagles weighing 9-11 kg were used. An induction dose of propofol anesthetic agent (7 mg/kg) was administered intravenously (1 ml/10 sec). Anesthetic depth was regulated by a continuous IV infusion of 0.7-1.0 mg/kg/min of propofol. The dog, placed in a supine position with its jaws immobilized, was intubated with a size 5 endotracheal tube, and such physiological signs as rectal temperature, EKG, end tidal CO₂, and SPO₂ were monitored continuously throughout the experiment. A bronchoscope containing the fiberoptic bundles in the cytological channel was inserted dorsal to the endotracheal tube, immobilized, and data were collected at 2 ms, 3 ms, 4 ms, and 5 ms sampling times. FIG. 8 is an example of the data obtained with the system. Analysis of the time-dependent photon counts gives a value of ciliary beat frequency of 9 Hz. [note: do we have the metachronal wave period for an in vivo experiment?]

### EXAMPLE 2

### Measurements of Ciliary Activity In Vitro in Samples of Native Epithelium

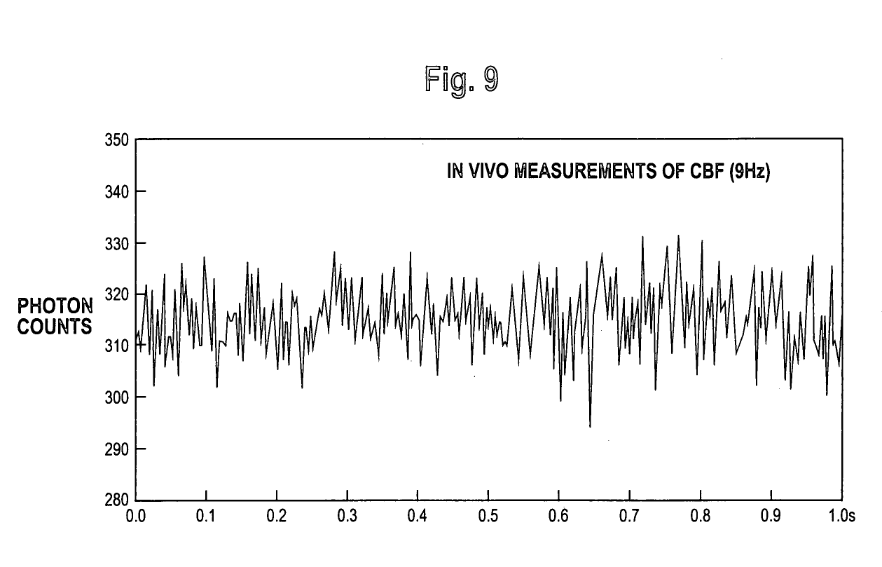

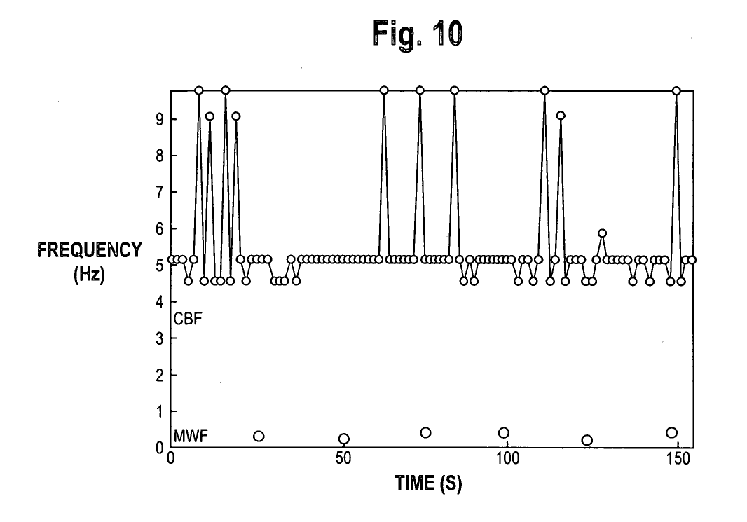

The posterior tracheal membrane of a bovine trachea was removed and maintained in Medium 199 containing 1% antibiotics. A 2 mm² piece was cut, placed on a coverslip, and kept moist with the culture medium. The fiberoptic probe was positioned with a micrometer until it barely grazed the surface of the epithelium and continuous measurements of ciliary activity were made with a sampling time of 3 ms. FIG. 9 is an example of the photon count sequences obtained in this experiment over a period of about 10 seconds. FIG. 10 shows the ciliary beat frequency and the metachronal wave period calculated from the data in FIG. 9. The ciliary beat frequency is about 9 Hz and the metachronal wave period is about 5??? seconds.

While these examples refer to tracheal ciliary beat, it is appreciated that this invention can be used for any remote oscillatory sensing activity, as long as the oscillation frequency is less that about 5000 Hz and as long as the amplitude of the oscillatory activity is above the noise level of the detection system. The technology allows the continuous and simultaneous measurement of ciliary beat frequency and beat pattern in real time, thus providing information that can be used to develop a better understanding of the underlying mechanisms regulating ciliary activity than is presently possible. The fiber-optic system can be used for studies in animals with intact epithelia, so that neural and humoral phenomena that affect the ciliated epithelia can be studied. The system can be passed through or incorporated into a bronchoscope or an endoscope, to simultaneously measure ciliary beat frequency and beat pattern in real time without damage to tissue. This can provide clinicians with new information about conditions affecting ciliated passages, such as the conducting airways of the respiratory tract, the Fallopian tubes, or ciliated ependymal cells in the brain. Thus this system can potentially can be used for the diagnosis of ciliary dysfunction. Industrial applications of this technology include the detection and analysis of vibrations or asymmetries in rotating machinery, or oscillations that occur in any system, as long as the oscillation frequency is below about 5000 Hz and as long as the oscillation amplitude can be discriminated from ambient noise. The fiber-optic design allows such sensing to be accomplished in remote locations. Finally, the control and analysis system designed for this technology could be applied to other applications involving the real time analysis of complex non-linear two dimensional data sets. Other biological movements such as tremor, vibration of the eardrum and vocal cords can be assessed and used for scientific and diagnostic evaluation. Thus, it would be useful in many industrial applications where measurement of oscillatory motion or vibrations are important.

It can therefore be appreciated that a new and novel method and apparatus for measuring oscillatory motion has been described. While the invention has been described in connection with a preferred embodiment thereof, it will be appreciated that various changes and modifications can be made without departing from the spirit and scope of the invention as defined in the appended claims. As a result, the invention is not to be limited by the foregoing embodiments, but only by the following claims.

1. A method of measuring nonstationary oscillatory motion of a sample, said method comprising the steps of: illuminating said sample with an illuminating optical fiber;
detecting reflected backscattered light from said sample with a plurality of detecting optical fibers;
coupling each optical fiber of said plurality of detecting optical fibers with a modulating optical fiber; and
generating measurements of said nonstationary oscillatory motion of said sample.

2. The method of claim 1 further comprising a step of splitting a light beam from a light source.

3. The method of claim 2 wherein said step of splitting a light beam comprises a step of generating an incident light beam and a modulating light beam.

4. The method of claim 3 further comprising a step of coupling said modulated light beam to a plurality of modulating optical fibers.

5. The method of claim 3 wherein said step of coupling each optical fiber of said plurality of detecting optical fibers with a modulating optical fiber comprises individually coupling each optical fiber of said plurality of detecting optical fibers with a separate modulating fiber.

6. The method of claim 2 wherein said step of detecting reflectedbackscattered light from said sample with a plurality of detecting optical fibers comprises detecting light with a plurality of detecting optical fibers arranged in a predetermined arrangement.

7. The method of claim 6 wherein said step of detecting light with a plurality of detecting optical fibers arranged in a predetermined arrangement comprises detecting light with a plurality of detecting optical fibers arranged symmetrically around said illuminating optical fiber.

8. The method of claim 1 further comprising a step of coupling each photodetector of a plurality of photodetectors to a pair of optical fibers, each pair of optical fibers having a detecting optical fiber and a modulating optical fiber.

9. The method of claim 8 further comprising a step of coupling a computer to said plurality of photodetectors.

10. The method of claim 1 wherein said step of generating measurements of said nonstationary oscillatory motion comprises generating measurements of said ciliary nonstationary oscillatory motion of an organic tissue sample.

11. The method of claim 1 further comprising a step of generating power spectral densities of photon count sequences using wavelet analysistransformation.

12. The method of claim 1 further comprising a step of generating power spectral densities of photon count sequences using periodogram convolution analysis.

13. The method of claim 1 further comprising a step of generating power spectral densities of photon count sequences using cumulative autocorrelation analysis.

14. The method of claim 1 further comprising a step of deriving a ciliary beat frequency and a metachronal wave period of the cilia derived from a frequency spectrum obtained from power spectral densities.

15. A method of measuring nonstationary oscillatory motion of a sample, said method comprising the steps of:
illuminating said sample with an illuminating optical fiber;
detecting reflectedbackscattered light from said sample with a plurality of detecting optical fibers positioned around said illuminating optical fiber in a predetermined arrangement; and
generating measurements of said nonstationary oscillatory motion of said sample.

16. The method of claim 15 further comprising a step of splitting a light beam into an incident light beam and a modulating light beam.

17. The method of claim 16 further comprising a step of coupling said modulated light beam to a plurality of modulating optical fibers.

18. The method of claim 17 further comprising a step of coupling each optical fiber of said plurality of detecting optical fibers with a modulating optical fiber of said plurality of modulating fibers.

19. The method of claim 15 wherein said step of generating measurements of said nonstationary oscillatory motion comprises generating measurements of said ciliary nonstationary oscillatory motion of an organic tissue sample.

20. The method of claim 15 further comprising a step of generating power spectral densities of photon count sequences using wavelet transformationanalysis.

21. The method of claim 15 further comprising a step of generating power spectral densities of photon count sequences using periodogram convolution analysis.

22. The method of claim 15 further comprising a step of generating power spectral densities of photon count sequences using cumulative autocorrelation analysis.

23. The method of claim 15 further comprising a step of deriving a ciliary beat frequency and a metachronal wave period of the cilia derived from a frequency spectrum obtained from power spectral densities.

24. A method of measuring nonstationary oscillatory motion of a sample, said method comprising the steps of:
illuminating said sample with an illuminating optical fiber;
detecting reflectedbackscattered light from said sample with a plurality of detecting optical fibers symmetrically positioned around said illuminating optical fiber;
coupling each optical fiber of said plurality of detecting optical fibers with a modulating optical fiber of a plurality of modulating optical fibers; and
generating measurements of ciliary nonstationary oscillatory motion of an organic tissue.

25. The method of claim 24 further comprising a step of splitting a light beam from a light source into an incident light beam and a modulating light beam.

26. The method of claim 24 further comprising a step of coupling said modulated light beam to a plurality of modulating optical fibers.

27. The method of claim 24 further comprising a step of coupling each photodetector of a plurality of photodetectors to a pair of optical fibers, each pair of optical fibers having a detecting optical fiber and a modulating optical fiber.

28. The method of claim 27 further comprising a step of coupling to a computer to said plurality of photodetectors.

29. The method of claim 24 further comprising a step of generating power spectral densities of photon count sequences using wavelet transformationanalysis.

30. The method of claim 24 further comprising a step of generating power spectral densities of photon count sequences using periodogram convolution analysis.

31. The method of claim 24 further comprising a step of generating power spectral densities of photon count sequences using cumulative autocorrelation analysis.

32. The method of claim 24 further comprising a step of deriving a ciliary beat frequency and a metachronal wave period of the cilia derived from a frequency spectrum obtained from power spectral densities.

33. A method of measuring nonstationary oscillatory motion of a sample, said method comprising the steps of:
splitting a light beam from a light source into an incident light beam and a modulating light beam;
illuminating a sample with said incident light beam by way of an illuminating optical fiber;
detecting reflectedbackscattered light from said sample with a plurality of detecting optical fibers symmetrically positioned around said illuminating optical fiber;
coupling said modulated light beam to a plurality of modulating optical fibers;
coupling each optical fiber of said plurality of detecting optical fibers with a modulating optical fiber of said plurality of optical fibers;
coupling each photodetector of a plurality of photodetectors to a pair of optical fibers, each pair of optical fibers having a detecting optical fiber and a modulating optical fiber; and
generating measurements of ciliary nonstationary oscillatory motion of an organic tissue.

34. An apparatus for measuring nonstationary oscillatory motion of a sample, said apparatus
comprising:
a light source;
an illuminating optical fiber coupled to said light source; and
a plurality of detecting optical fibers positioned around said illuminating optical fiber in a predetermined arrangement and coupled to receive reflectedbackscattered light from said sample.

35. The apparatus of claim 34 wherein said light source comprises a laser light source.

36. The apparatus of claim 34 wherein said plurality of detecting optical fibers comprise single mode optical fibers.

37 The apparatus of claim 34 wherein said plurality of detecting optical fibers are arranged symmetrically around said illuminating optical fiber.

38. The apparatus of claim 34 further comprising a beam splitter coupled to said light source.

39. The apparatus of claim 34 further comprising a modulating optical fiber bundle having a plurality of modulating optical fibers.

40. The apparatus of claim 34 wherein each detecting optical fiber of said plurality of detecting optical fibers is coupled to a modulating optical fiber.

41. The apparatus of claim 34 further comprising a plurality of detectors, each detector being coupled to a pair of optical fibers comprising a detecting optical fiber and a modulating optical fiber.

42. An apparatus for measuring nonstationary oscillatory motion of a sample, said apparatus
comprising:
a light source;
an illuminating optical fiber coupled to said light source;
a plurality of detecting optical fibers positioned symmetrically around said illuminating optical fiber and coupled to receive reflectedbackscattered light from said sample;
a plurality of modulating optical fibers coupled to said plurality of optical fibers; and
a plurality of detectors, each detector being coupled to a pair of optical fibers comprising a detecting optical fiber and a modulating optical fiber.

43. An apparatus for measuring nonstationary oscillatory motion of a sample, said apparatus
comprising:
a light source;
an illuminating optical fiber coupled to said light source;
a plurality of detecting optical fibers coupled to receive reflectedbackscattered light from said sample; and
a plurality of modulating optical fibers wherein each modulating optical fiber is coupled to a detecting optical fiber of said plurality of detecting optical fibers.

44. The apparatus of claim 43 wherein said light source comprises a laser light source.

45. The apparatus of claim 43 wherein said plurality of detecting optical fibers comprise single mode optical fibers.

46. The apparatus of claim 43 wherein said plurality of detecting optical fibers are positioned around said illuminating optical fiber in a predetermined arrangement.

47. The apparatus of claim 43 further comprising a beam splitter coupled to said light source.

48. The apparatus of claim 43 further comprising a modulating optical fiber bundle having said plurality of modulating optical fibers.

49. An apparatus for measuring nonstationary oscillatory motion of a sample, said apparatus
comprising:
a laser light source;
a beam splitter coupled to said light source;
an illuminating optical fiber coupled to said light source;
a plurality of detecting optical fibers coupled to receive reflectedbackscattered light from said sample, wherein said plurality of detecting optical fibers are symmetrically positioned around said illuminating optical fiber;
a modulating optical fiber bundle having a plurality of modulating optical fibers, wherein each modulating optical fiber is coupled to a detecting optical fiber of said plurality of detecting optical fibers; and
a plurality of detectors, each detector being coupled to a pair of optical fibers comprising a detecting optical fiber and a modulating optical fiber.
